(19) United States
(12) Patent Application Publication
(10) Pub. No.: US 2025/0118061 A1
(43) Pub. Date: Apr. 10, 2025

(54) MATCHING LINES OF POINTS FROM VEHICLE LIDAR TO VISION DETECTED OBJECTS

(71) Applicant: MOBILEYE VISION TECHNOLOGIES LTD., Jerusalem (IL)

(72) Inventors: David BOUBLIL, Jerusalem (IL); Amittai Elia COHEN-ZEMACH, Ramat Gan (IL); Roy STEINBERG, Tel-Aviv (IL); Gilad Avraham BARACH, Jerusalem (IL)

(73) Assignee: MOBILEYE VISION TECHNOLOGIES LTD., Jerusalem (IL)

(21) Appl. No.: 18/909,511

(22) Filed: Oct. 8, 2024

Related U.S. Application Data
(60) Provisional application No. 63/588,902, filed on Oct. 9, 2023.

(51) Int. Cl. G06V 10/80; B60W 60/00; G01S 7/481; G01S 7/4865; G01S 17/86; G01S 17/894; G01S 17/931; G06V 20/58

(52) U.S. Cl. CPC G06V 10/811; G01S 7/4814; G01S 7/4865; G01S 17/86; G01S 17/894; G01S 17/931; G06V 20/58; B60W 60/0013; B60W 60/0015; B60W 2420/403; B60W 2420/408; B60W 2556/35

(57) ABSTRACT

In an embodiment, a computer-implemented method combines data from a lidar sensor and camera. A point cloud collected from the lidar sensor is received. The lidar sensor is mounted on a vehicle. A plurality of lines of points from the point cloud are identified such that each of the identified plurality of lines of points is at a substantially different angle from a plane of a road the vehicle is driving on. An image captured from the camera is received. The camera is mounted on the vehicle, the image having been captured substantially simultaneously with the point cloud. Using an image analysis algorithm, a plurality of objects in the image are identified. Respective objects from the plurality of objects are correlated with the identified plurality of lines of points.

### CROSS-REFERENCE TO RELATED APPLICATIONS

This application claims priority to U.S. Provisional Application No. 63/588,902 filed Oct. 9, 2024, which is hereby incorporated by reference in its entirety.

### FIELD

The field relates to sensor fusion.

### BACKGROUND

Lidar, or light detection and ranging, is a remote sensing technique that uses pulses of laser light to measure distances and create high-resolution maps of the surface of the earth or other objects. Lidar works by emitting a beam of light from a transmitter and measuring the time and intensity of the reflected signal from a receiver. By scanning the beam across a target area, lidar can generate a three-dimensional point cloud of data that represents the shape, elevation, and features of the terrain, vegetation, buildings, or other structures. Lidar can be mounted on vehicles to support driver assistance and autonomous vehicles.

ADAS, or advanced driver assistance systems, are technologies that enhance the safety and convenience of drivers and passengers by providing assistance, warnings, or interventions in various driving scenarios. ADAS can involve parking sensors, blind spot monitors, adaptive cruise control and lane keeping assist, to fully autonomous ones, such as self-parking and self-driving. ADAS rely on various sensors, cameras, radars, lidars, and software to perceive the environment, detect potential hazards, and communicate with the driver or other vehicles. ADAS can help reduce human error, improve traffic flow, lower fuel consumption, and prevent collisions and injuries.

Autonomous vehicles, also known as self-driving cars, are vehicles that can operate without human intervention or supervision, using sensors, cameras, software, and artificial intelligence to perceive and navigate their environment. Autonomous vehicles have the potential to improve road safety, mobility, efficiency, and environmental sustainability, by reducing human errors, traffic congestion, fuel consumption, and greenhouse gas emissions.

As mentioned above, lidar sensors can produce point clouds. Point clouds are collections of data points that represent the shape and surface of an object or a scene in three-dimensional space. In addition to lidar, point clouds can be generated from other sensors including radars and cameras. These point clouds can pose some challenges, such as noise, incompleteness, redundancy, and complexity, that require efficient and robust processing and representation methods.

Improved methods for interpreting point clouds are needed.

### SUMMARY

In an embodiment, a computer-implemented method combines data from a lidar sensor and camera. A point cloud collected from the lidar sensor is received. The lidar sensor is mounted on a vehicle. A plurality of lines of points from the point cloud are identified such that each of the identified plurality of lines of points is at a substantially different angle from a plane of a road the vehicle is driving on. An image captured from the camera is received. The camera is mounted on the vehicle, the image having been captured substantially simultaneously with the point cloud. Using an image analysis algorithm, a plurality of objects in the image are identified. Respective objects from the plurality of objects are correlated with the identified plurality of lines of points.

System, device, and computer program product aspects are also disclosed.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### DESCRIPTION OF DIAGRAMS

The features and advantages of the example embodiments described herein will become apparent to those skilled in the art to which this disclosure relates upon reading the following description, with reference to the accompanying drawings.

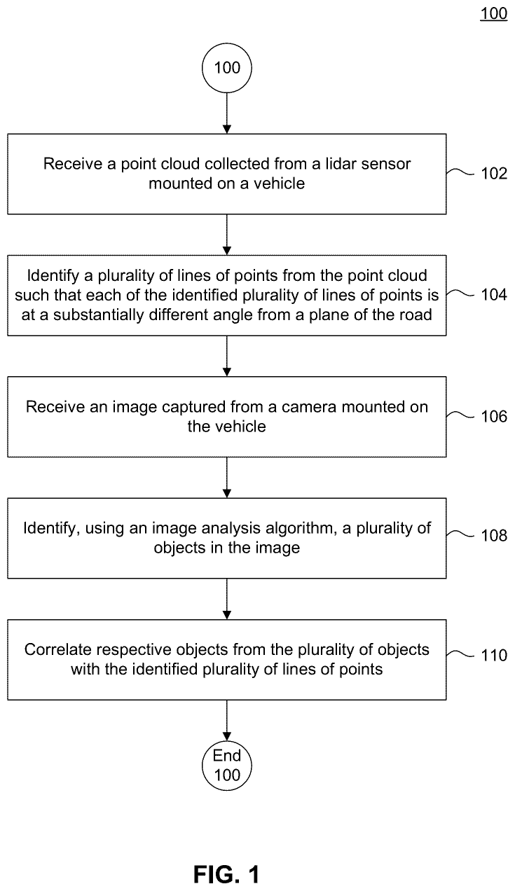

FIG. 1 is a flowchart illustrating a method for correlating vision-detected objects with lines of points detected with lidar.

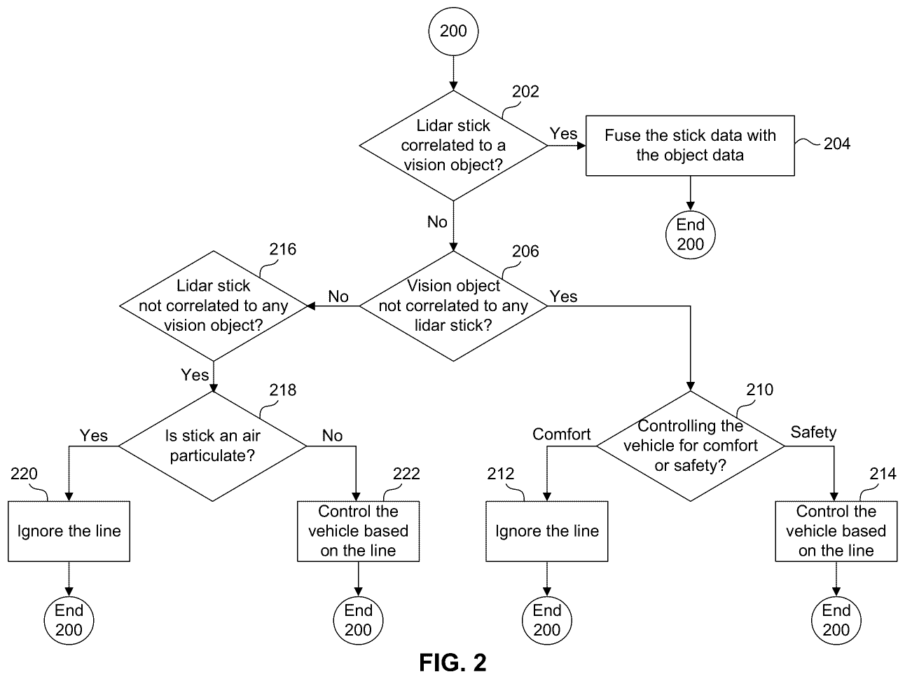

FIG. 2 is a flowchart illustrating a method for fusing data between the vision and lidar data and controlling the vehicle based on the fused data.

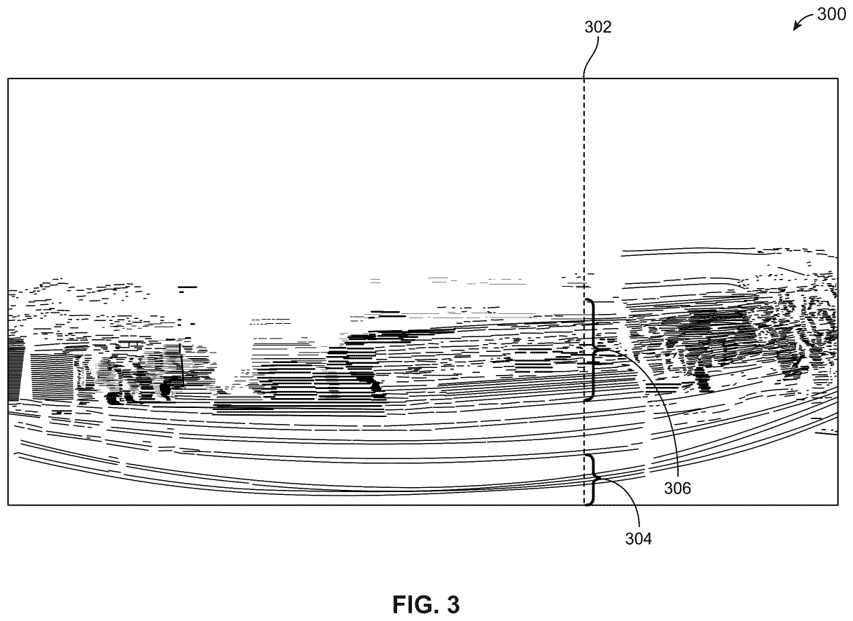

FIG. 3 illustrates an example of data collected from a lidar sensor on a vehicle.

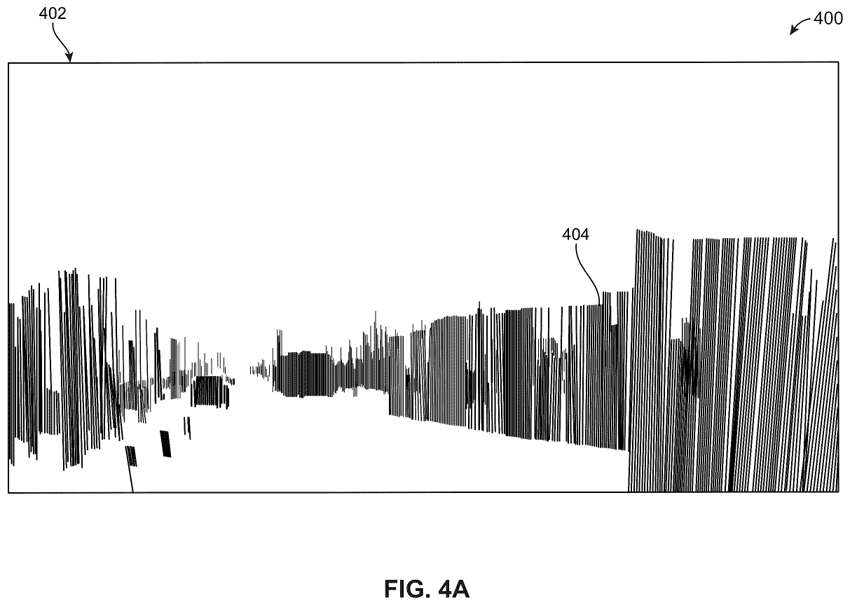

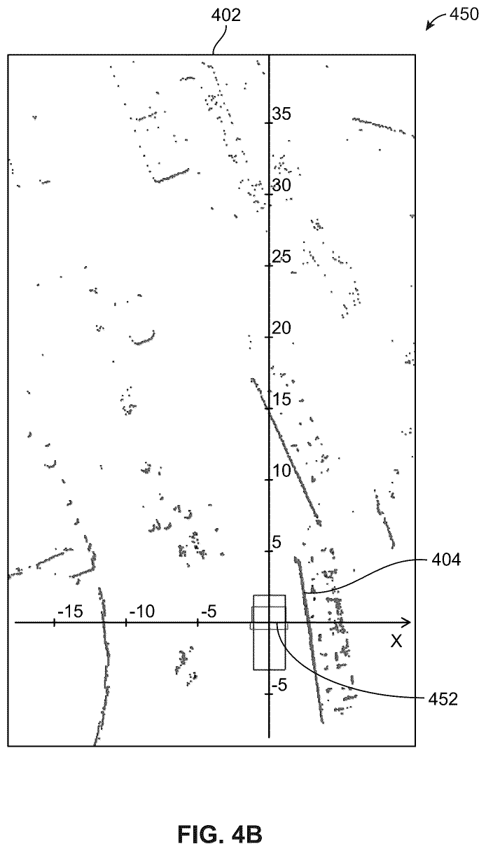

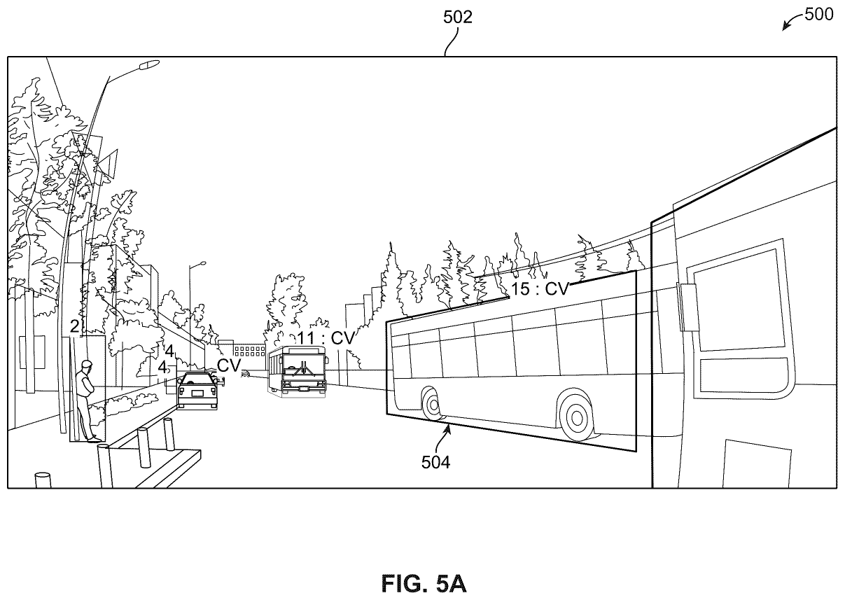

FIGS. 4A-4B illustrate an example of clustering points captured from a lidar sensor into lines along a common azimuth.

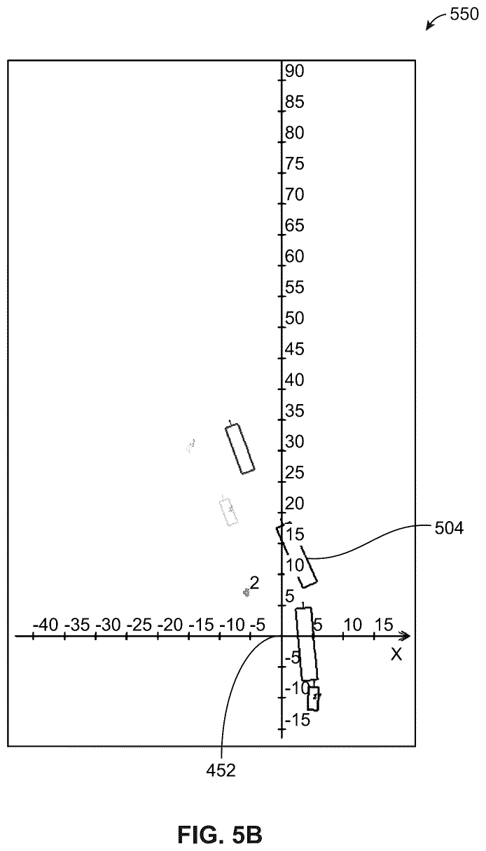

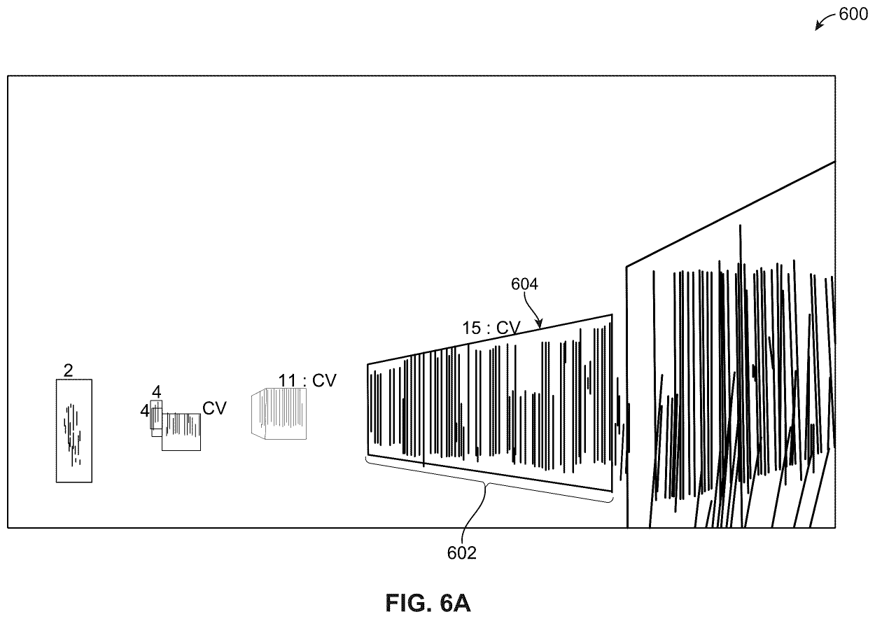

FIGS. 5A-5B illustrate an example of detecting objects using computer vision.

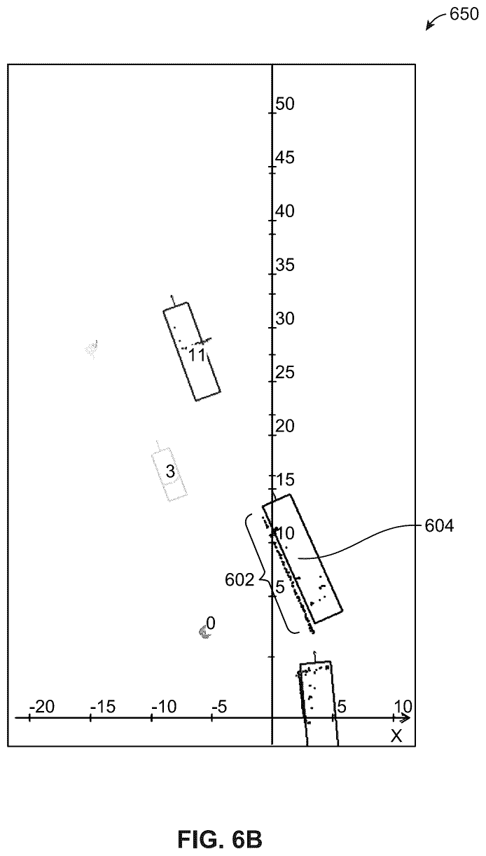

FIGS. 6A-6B illustrate an example of correlating the objects using computer vision with the lines along a common azimuth.

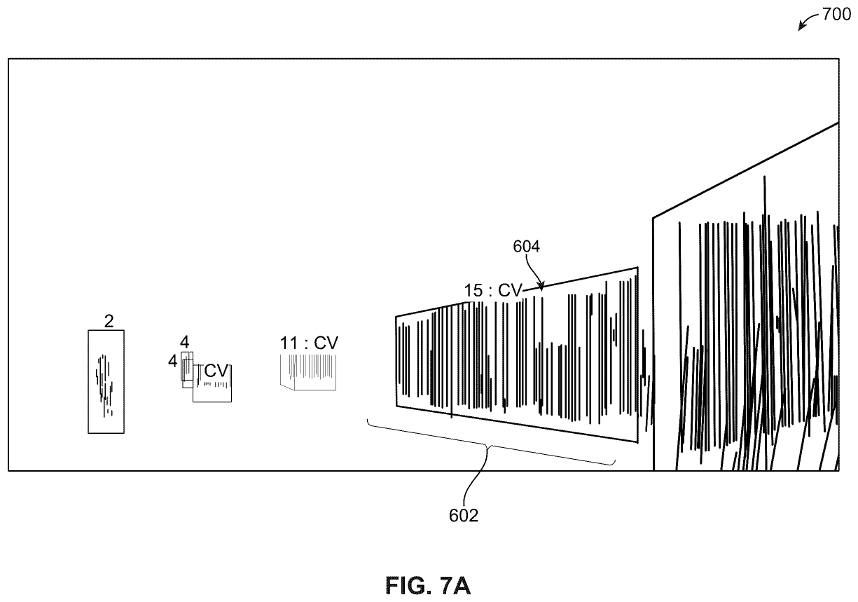

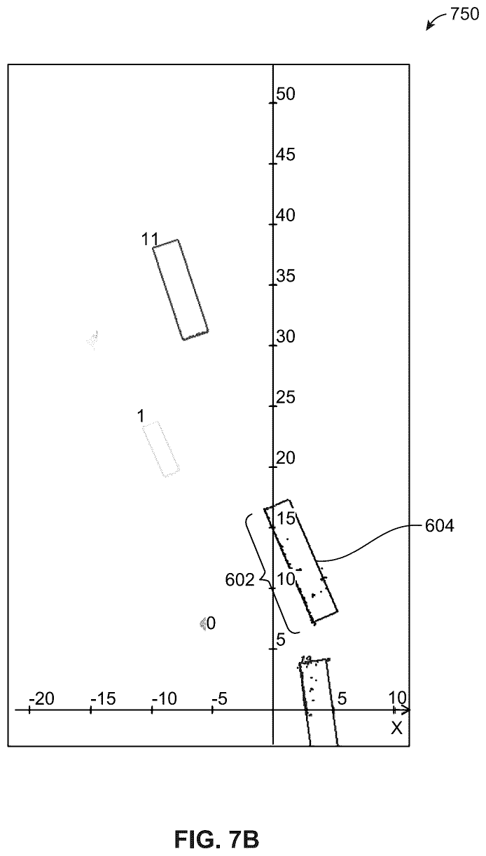

FIGS. 7A-7B illustrate an example of fusing the correlated objects and the lines.

In the drawings, like reference numbers generally indicate identical or similar elements. Additionally, generally, the left-most digit(s) of a reference number identifies the drawing in which the reference number first appears.

Aspects of the present disclosure will be described with reference to the accompanying drawings.

### DETAILED DESCRIPTION

Sensor fusion is the process of combining data from multiple sources, such as cameras, radars, lidars, or inertial measurement units, to obtain a more accurate and comprehensive representation of the environment. Embodiments combine lidar with computer vision into sensor fusion.

More particularly, embodiments involve determining columns of lidar data, referred to as sticks. The lidar data is collected from a lidar sensor fixed to a vehicle. Sticks, as the term is used herein, are lines of lidar data captured at a common azimuth angle, the lines orientation represent an angle that substantially differs from the plane of the road. Typically, lidar sensors conduct sweeps by measuring all the points detected in a single azimuth column. A single azimuth column can have multiple sticks. For example, the same azimuth, the lidar sensor may detect a curb and a fire hydrant. Both the curb and the fire hydrant have angles that substantially differ from the road plane.

In addition to lidar sensing, embodiments involve determining objects from computer vision data. Cameras are mounted to the vehicle and collect image data substantially simultaneously with the lidar sensor. Computer vision algorithms are applied to the collected image data to identify objects, such as other vehicles and pedestrians. The object detection algorithm may determine a classification of the object and a size and shape of the object.

According to an embodiment, objects identified as sticks from the lidar data are correlated with objects identified using computer vision. In an example, this correlation may enrich the lidar data to include a classification of the object. In another example, this correlation may be used to identify false positives. For example, if the computer vision identifies an object that is not identified from the lidar data, the object identified from the computer vision may be determined to be a false-positive and ignored.

In one possible implementation, this sensor fusion may only be used in operations relating to driving the vehicle for optimum comfort. In operations relating to safety, vision and lidar may be treated independently.

FIG. 1 is a flowchart illustrating a method for correlating vision-detected objects with lines of points detected with lidar.

At 102, a point cloud collected from a lidar sensor is received. As mentioned above, a point cloud is a collection of data points that represent the shape and surface of an object or a scene in three-dimensional space. Each point in the point cloud comprises a location in three-dimensional space (e.g., elevation, azimuth, and range), a timestamp when the location was detected, and a reflectivity detected at the location. Lidar reflectivity is a measure of how much light is scattered back to a lidar sensor by a target object. In a further embodiment, each point can additionally include a Doppler value detected at the location. A Doppler value is a measure of the change in frequency or wavelength of an electromagnetic wave due to the relative motion of the source and the observer. In this way, the Doppler value may indicate a relative motion of the target object when the point was detected.

As described above, lidar is a remote sensing technique that uses pulses of laser light to measure the distance and reflectance of objects on the ground or in the air. A lidar system consists of a laser source, a scanner, a detector, and a computer. The laser source emits a beam of light that is directed by the scanner to scan a certain area or angle. The detector receives the reflected or scattered light from the target and measures the time it takes for the light to travel back. The computer then calculates the distance and the position of the target based on the speed of light and the angle of the scanner. By rotating or scanning the device horizontally and vertically, the lidar can capture multiple points of reflection and form a sweep, or a series of measurements that cover a certain area or volume. Examples of different types of lidar sensors available include a direct detection based on time-of-flight lidar sensor, a frequency modulated continuous wave (FMCW) lidar sensor, and an amplitude modulated continuous (AMCW) lidar sensor.

In this way, by sending out short bursts of laser light and detecting the echoes, lidar can create a precise picture of the terrain or the environment. A lidar sweep involves sweeping a laser beam across a specified range or direction. For example, a lidar system may direct a laser along a plurality of elevation angles along a common azimuth angle, sampling each return signal at each elevation angle to determine a range (and possibly a Doppler value). When all the elevation angles are sampled at the common azimuth angle, the azimuth angle may be incremented and the elevation angles may be sampled again. In this way, a lidar sensor can sample points across a wide range of three-dimensional space. To steer the laser beams to a particular elevation and azimuth, different scanning may be used, including mechanical scanning, solid-state scanning, MEMs mirror steering, and optical phase array (OPA) steering.

In other examples, beam steering may be avoided entirely by using a flash lidar system. Instead of a point-by-point scanning of the field of view, these systems gather time-of-flight data points of entire horizontal planes simultaneously with each flash.

FIG. 3 is a diagram 300 illustrating an example of points collected from a lidar sensor on a vehicle. The points sampled may come from a single sweep over a field of view of the lidar sensor. In another embodiment, the points may be sampled from multiple successive or nearly successive sweeps of the lidar sensor. In still another embodiment, the points may be captured over multiple sweeps of different lidar sensors mounted at different points around the vehicle captured nearly simultaneously.

At 104, a plurality of lines of points from the point cloud is identified such that each of the identified plurality of lines of points is at a substantially different angle from a plane of a road the vehicle is driving on. As mentioned above, the plurality of lines of points may be referred to as “sticks.” Each of the plurality of sticks may include points captured at a vertical common azimuth angle from the lidar sensor. For example, the points may be successively captured from a single vertical sweep.

As mentioned above, the points in each stick are at a substantially different angle from a plane of a road the vehicle is driving on, and the plane of the road is substantially horizontal. The substantially different angle is set to a minimum in accordance with drivability over the road. In some embodiments the substantially different angle can be in the range of 45-90 degrees, in other embodiments in the range of 75-90 degrees, and in further embodiments substantially close to 90 degrees.

An example operation is described with respect to diagram 300 in FIG. 3. As mentioned above, diagram 300 illustrates a point cloud. The point cloud includes a plurality of points captured at an azimuth angle 302. The plurality of points captured at azimuth angle 302 includes a plurality of points 304 at a nearly horizontal angle. In the example in FIG. 3, the object detected at the nearly horizontal angle may be a street. The plurality of points captured at azimuth angle 302 includes a plurality of points 306 at a nearly vertical angle. In the example in FIG. 3, the object detected at the nearly vertical angle may be a bus. The plurality of points 306 comprise a stick. The process is repeated over a plurality of azimuth angles over the field of view to determine a plurality of sticks.

To determine if a sequence of points along an azimuth is at a horizontal or vertical angle, each point may for example be converted from spherical (elevation, azimuth, range) to rectangular coordinates (x, y, z). If variation on a sequence of points on the z plane is below a threshold, then the sequence of points may have different x, y coordinates on substantially the same z plane. If the sequence of points is on substantially the same z plane, the sequence of points may be at a horizontal angle. Similarly, if variation of a sequence of points on the x and y planes are below a threshold, then the sequence of points may have substantially the same horizontal x-y position with varying z altitudes. If the sequence of points has substantially the same horizontal x-y position with varying z altitudes, the sequence of points may be at a vertical angle.

FIGS. 4A-4B illustrate an example of clustering points captured from a lidar sensor into lines along a common azimuth. FIG. 4A shows a diagram 400 with a plurality of sticks 402 determined from the point cloud illustrated in FIG. 3. Diagram 400 illustrates the plurality of sticks 402 from a perspective of a lidar sensor on a vehicle. FIG. 4B shows a diagram 450 with plurality of sticks 402 from a nadir perspective. Diagram 450 shows an origin 452 where the vehicle is located.

Continuing the example from FIG. 3, plurality of points 306 at a substantially vertical angle are clustered into a stick 404. In rectangular coordinates, stick 404 may be specified by an x-y coordinate and two z coordinates, one specifying the stick 404's bottom and the other specifying the stick 404's top. Stick 404 is illustrated in both diagram 400 in FIG. 4A and diagram 450 in FIG. 4B.

At 106, an image captured from a camera is received. The camera is mounted on the vehicle and the image may be a photographic image captured substantially simultaneously with the point cloud. In an embodiment, multiple cameras are mounted around the exterior of the vehicle, such as on the front, rear, side mirrors, or roof. These cameras can capture images of the vehicle's surroundings from different angles and perspectives, and feed them to a display screen or a computer system inside the vehicle. The cameras can help the driver or the vehicle itself to sense and monitor the traffic conditions, road hazards, blind spots, parking spaces, or other objects or events around the vehicle.

In the embodiment where multiple cameras are used, multiple images captured from the respective cameras may be stitched together to produce the image received at step 106. Stitching images together captured from multiple cameras is a process of combining overlapping or adjacent photos into a larger and more complete scene. To stitch images together, the images may need to have some common features or reference points that can be matched and aligned. Then, the images may be warped, blended, and cropped to create a seamless and natural-looking result.

At 108, a plurality of objects are identified in the image received at step 106. The identification is completed using an image analysis algorithm. The image analysis algorithm may output a set of bounding boxes that indicate the spatial location and size of each detected object, as well as a class label that indicates the category of the object, such as person, car, bus, dog, etc. The image analysis algorithm may be three-dimensional in that it aims to estimate not only the two-dimensional location and size of objects, but also their three-dimensional shape, pose, and orientation in the image.

Three-dimensional object detection models typically output a set of cuboids or other geometric primitives that represent the three-dimensional bounding volume of each detected object, as well as a class label and a pose vector that indicate the category and the orientation of the object, respectively. Example image analysis algorithms that may be used to detect objects at step 108 include YOLO (You Only Look Once), Faster R-CNN (Faster Region-based Convolutional Neural Network), PointRCNN, and CenterNet.

FIGS. 5A-5B illustrate an example of detecting objects using computer vision. FIG. 5A shows a diagram 500 with a photographic image 502 as may be received for example in step 106. Diagram 500 also includes a plurality of bounding boxes, including a bounding box 504, overlaid on photographic image 502. The plurality of bounding boxes are shown in diagram 500 from a perspective of a camera that took photographic image 502. FIG. 5B shows a diagram 550 with the plurality of bounding boxes, including bounding box 504, from a nadir perspective. Diagram 550 also shows origin 452 where the vehicle is located.

At 110, respective objects from the plurality of objects determined at step 104 are correlated with the identified sticks at step 108. The correlation may involve determining whether the respective objects from the plurality of objects are located in substantially the same position as the respective stick. For example, when a stick is located within an object's bounding box or within a threshold distance from the object's bounding box, the stick may be correlated with the object. Alternatively or additionally, the correlation may involve determining whether the respective objects from the plurality of objects have substantially the same shape as the respective sticks. For example, when a stick has a similar height with an object's bounding box, the stick may be more likely to be correlated to the object. In addition, when a group of neighboring sticks together have a shape similar to a surface of an object's bounding box, the group of sticks may be more likely to be correlated to the object.

FIGS. 6A-6B illustrate an example of correlating the objects using computer vision with the lines along a common azimuth. FIG. 6A shows a diagram 600 with a plurality of sticks 602 correlated to an object with bounding box 604. Diagram 600 illustrates the plurality of sticks 602 and bounding box 604 from a perspective of a lidar sensor and camera on a vehicle. FIG. 6B shows a diagram 650 with plurality of sticks 602 and bounding box 604 from a nadir perspective.

FIG. 2 is a flowchart illustrating a method 200 for fusing data between the vision and lidar data and controlling the vehicle based on the fused data.

At 202, it is determined whether a stick from the sticks determined at step 104 is correlated to an object determined at step 108. This step is described above with respect to step 110 in FIG. 1. This analysis may be conducted for every line identified in step 104 and/or for every object determined at step 108. When a line and object are correlated, operation proceeds to step 204. When, at 206, it is determined that an object does not correlate to any of the sticks, operation proceeds to step 216. When, at 216, it is determined that an object from the object does not correlate to any of the sticks, operation proceeds to step 218.

At 204, data representing the stick is fused with data representing the object. As mentioned above, sensor fusion is a process of combining data from multiple sensors to obtain a more accurate and reliable representation of the environment or a phenomenon of interest. Sensor fusion can enhance the performance, robustness, and functionality of adaptive driver assistance and autonomous driving. Sensor fusion can also provide benefits such as reducing uncertainty, resolving conflicts, increasing resolution, and exploiting complementary information from different sensor modalities.

As mentioned above, the image analysis conducted at step 108 may involve determining a classification of the object. The classification is the category of the object, such as person, car, bus, dog, etc. Step 104 may include enriching the stick data with the classification determined for the corresponding object. The data enrichment may include associating the stick with the classification. Thus, to the extent that an autonomous driving or ADAS system may control the vehicle differently based on whether an object at a particular location has a different classification, the autonomous driving or ADAS system may behave as if an object with the associated classification is located at the location of the stick.

As mentioned above, data fusing may also involve adjusting data from various sensors based on the relative accuracy of the sensors. A lidar sensor may have a finer range resolution than cameras. Thus, fusing data from various sources may involve adjusting a location of a bounding box determined at step 108 to a location of a corresponding line of sticks. This is illustrated, for example, in FIGS. 7A-B.

FIGS. 7A-7B illustrate an example of fusing the correlated objects and the lines. FIG. 7A shows a diagram 700 with the plurality of sticks 602 correlated to an object with bounding box 604. Diagram 700 illustrates the plurality of sticks 602 and bounding box 604 from a perspective of a lidar sensor and camera on a vehicle. FIG. 7B shows a diagram 750 with the plurality of sticks 602 and bounding box 604 from a nadir perspective. As shown in these figures, the location of bounding box 604 has been adjusted such that one side of bounding box 604 is along the plurality of sticks 602.

In an embodiment, the fusion described with respect to step 204 may be used to control a vehicle by an autonomous driving or ADAS system in some contexts but not in others. For example, in some cases, an autonomous driving or ADAS system may be controlling a vehicle for safety while in other contexts, an autonomous driving or ADAS system may be controlling a vehicle for comfort.

When controlling a vehicle for safety, an autonomous driving or ADAS system may determine a safe following distance from the car in front of it, a safe lateral distance to ensure that a vehicle can identify when lateral safety may be compromised by a driver unsafely cutting into its lane, a right-of-way decision based on line lanes, traffic signs, traffic lights, and conduct of other drivers, areas of limited visibility where hazards may exist but are included, and ways to avoid collisions.

However, bringing the vehicle all the way to a safe minimum following distance or a safe lateral distance may cause the vehicle to drive very aggressively to the point where it may affect comfort of the passengers in the car. Thus, in addition to determining safe minimum following distance or a safe lateral distance, an autonomous driving or ADAS system may determine minimum distances for controlling the vehicle for maximum comfort of the vehicle. In an embodiment, the fusion in step 204 may occur when a vehicle is being controlled for comfort but not when the vehicle is being controlled for safety. In this way, the camera and lidar data remains independent, redundant sources of data to ensure safe operation of the vehicle.

When an object determined using image analysis (decision block 206) is determined not to correlate to any of the sticks in the scene, operation may again vary depending on whether the vehicle is being controlled for comfort or for safety. At 210, a determination is made as to whether the vehicle is being controlled for comfort of an occupant or for safety. When the vehicle is merely being controlled for comfort, the object may be ignored as a false positive at 212. At 214, when the vehicle is merely being controlled for safety, the autonomous driving or ADAS system may control the vehicle based on the object to ensure that the vehicle is driven safely in accordance with the object.

When a stick using lidar is determined not to correlate to any of the objects in the scene (at 216), whether the stick is an air particulate is determined at 218. An air particulate is a tiny solid or liquid particle that is suspended in the air, such as dust, smoke, fog, precipitation, pollen, or pollution. Lidar can detect air particulates by sending a beam of light into the air and measuring the amount and direction of the light that is scattered or reflected back by the particles. One possible method to detect air particulates in an image is to use remote sensing techniques that measure the amount and characteristics of the light reflected or scattered by the particles in different wavelengths.

Another possible method to detect air particulates in an image is to use machine learning algorithms that can classify and quantify the aerosols based on their features and patterns. For example, convolutional neural networks (CNNs) can learn to extract and recognize the features of aerosols from large sets of labeled images, and then apply them to new images to estimate the optical depth, size distribution, and composition of the aerosols.

When the stick is determined to be the air particulate, the stick is ignored at 220 in controlling the vehicle. For example, the stick is not used in minimum following distance or a safe lateral distance for the vehicle, either when controlling the vehicle for comfort or for safety.

At 222, when the stick is determined to not be the air particulate, the vehicle is controlled based on the stick. For example, the stick is used to determine a minimum following distance or a safe lateral distance to control the vehicle for both comfort and safety.

As mentioned above, method 100 in FIG. 1 and method 200 in FIG. 2 may be implemented on a computing device. A computing device may include one or more processors (also called central processing units, or CPUs). The processor may be connected to a communication infrastructure or bus. The computer device may also include user input/output device(s), such as monitors, keyboards, pointing devices, etc., which may communicate with communication infrastructure through user input/output interface(s).

One or more of the processors may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc. Similarly, one or more of the processors may be a deep learning processor (DLP). A DLP is an electronic circuit designed for deep learning algorithms, usually with separate data memory and dedicated instruction set architecture. Like a GPU, a DLP may leverage high data-level parallelism, a relatively larger on-chip buffer/memory to leverage the data reuse patterns, and limited data-width operators for error-resilience of deep learning.

The computing device may also include a main or primary memory, such as random access memory (RAM). The main memory may include one or more levels of cache. Main memory may have stored therein control logic (i.e., computer software) and/or data.

The computing device may also include one or more secondary storage devices or memory. The secondary memory may include, for example, a hard disk drive, flash storage and/or a removable storage device or drive.

The computing device may further include a communication or network interface. The communication interface may allow the computing device to communicate and interact with any combination of external devices, external networks, external entities, etc. For example, the communication interface may allow the computer system to access external devices via a network, which may be wired and/or wireless (or a combination thereof), and which may include any combination of LANs, WANs, the Internet, etc

The computing device may also be any of a rack computer, server blade, personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

Although several embodiments have been described, one of ordinary skill in the art will appreciate that various modifications and changes can be made without departing from the scope of the embodiments detailed herein. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as critical, required, or essential features or elements of any or all the claims. The invention(s) are defined solely by the appended claims including any amendments made during the pendency of this application and all equivalents of those claims as issued.

Identifiers, such as “(a),” “(b),” “(i),” “(ii),” etc., are sometimes used for different elements or steps. These identifiers are used for clarity and do not necessarily designate an order for the elements or steps.

Moreover, in this document, relational terms such as first and second, and the like may be used solely to distinguish one entity or action from another entity or action without necessarily requiring or implying any actual such relationship or order between such entities or actions. The terms “comprises”, “comprising”, “has”, “having”, “includes”, “including”, “contains”, “containing” or any other variation thereof, are intended to cover a non-exclusive inclusion, such that a process, method, article, or apparatus that comprises, has, includes, or contains a list of elements, does not include only those elements but may include other elements not expressly listed or inherent to such process, method, article, or apparatus. An element preceded by “comprises . . . a”, “has . . . a”, ‘includes . . . a”, “contains . . . a” does not, without additional constraints, preclude the existence of additional identical elements in the process, method, article, and/or apparatus that comprises, has, includes, and/or contains the element. The terms “a” and “an” are defined as one or more unless explicitly stated otherwise herein. The terms “approximately”, “about” or any other version thereof, are defined as being close to as understood by one of ordinary skill in the art. A device or structure that is “configured” in a certain way is configured in at least that way, but may also be configured in ways that are not listed. For the indication of elements, a singular or plural forms can be used, but it does not limit the scope of the disclosure and the same teaching can apply to multiple objects, even if in the current application an object is referred to in its singular form.

The embodiments detailed herein are provided to allow the reader to quickly ascertain the nature of the technical disclosure. It is submitted with the understanding that it will not be used to interpret or limit the scope or meaning of the claims. In addition, in the foregoing Detailed Description, it is demonstrated that multiple features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment in at least some instances. Thus, the following claims are hereby incorporated into the Detailed Description, with each claim standing on its own as separately claimed subject matter

What is claimed is:

1. A computer-implemented method for combining data from a lidar sensor and camera, comprising:
receiving a point cloud collected from the lidar sensor, the lidar sensor being mounted on a vehicle;
identifying a plurality of lines of points from the point cloud such that each of the identified plurality of lines of points is oriented at a substantially different angle from a plane of a road the vehicle is driving on;
receiving an image captured from the camera, the camera being mounted on the vehicle and the image having been captured substantially simultaneously with the point cloud;
identifying, using an image analysis algorithm, a plurality of objects in the image; and
correlating respective objects from the plurality of objects with the identified plurality of lines of points.

2. The method of claim 1, further comprising, when a line of points from the plurality of lines of points is correlated to an object from the plurality of objects, enriching the line with a classification of the object determined using the image analysis algorithm.

3. The method of claim 1, further comprising, when an object from the plurality of objects is determined not to correlate to any of the plurality of lines of points, identifying the object as a false positive.

4. The method of claim 3, further comprising:
when controlling the vehicle for comfort of a rider of the vehicle, ignoring the object identified as the false positive; and
when controlling the vehicle for safety, controlling the vehicle based on the object identified as the false positive.

5. The method of claim 1, further comprising, when a line of points from the plurality of lines of points is determined not to correlate to any of the plurality of objects:
controlling the vehicle based on the line.

6. The method of claim 5, further comprising, when the line of points from the plurality of lines of points is determined not to correlate to any of the plurality of objects:
determining whether the line is an air particulate;
when the line is determined to be the air particulate, ignoring the line when controlling the vehicle; and
when the line is not determined to be the air particulate, controlling the vehicle based on the line.

7. The method of claim 1, wherein each of the plurality of lines of points is captured at a vertical common azimuth angle from the lidar sensor.

8. The method of claim 7, wherein each point in the plurality of lines of points is captured by the lidar sensor sequentially.

9. The method of claim 1, wherein the plane of the road is substantially horizontal.

10. The method of claim 9, wherein the substantially different angle is set to a minimum in accordance with drivability over the road.

11. The method of claim 1, wherein the correlating comprises determining whether the respective objects from the plurality of objects are located in substantially the same position as respective lines from the plurality of lines of points.

12. The method of claim 1, wherein the correlating comprises determining whether the respective objects from the plurality of objects have substantially the same shape as the respective lines from the plurality of lines of points.

13. A non-transitory computer readable medium including instructions for combining data from a lidar sensor and camera that causes a computing system to perform operations comprising:
receiving a point cloud collected from the lidar sensor, the lidar sensor being mounted on a vehicle;
identifying a plurality of lines of points from the point cloud such that each of the identified plurality of lines of points is oriented at a substantially different angle from a plane of a road the vehicle is driving on;
receiving an image captured from the camera, the camera being mounted on the vehicle and the image having been captured substantially simultaneously with the point cloud;
identifying, using an image analysis algorithm, a plurality of objects in the image; and
correlating respective objects from the plurality of objects with the identified plurality of lines of points.

14. The non-transitory computer readable medium of claim 13, the operations further comprising, when a line of points from the plurality of lines of points is correlated to an object from the plurality of objects, enriching the line with a classification of the object determined using the image analysis algorithm.

15. The non-transitory computer readable medium of claim 13, the operations further comprising, when an object from the plurality of objects is determined not to correlate to any of the plurality of lines of points, identifying the object as a false positive.

16. The non-transitory computer readable medium of claim 15, the operations further comprising:
when controlling the vehicle for comfort of a rider of the vehicle, ignoring the object identified as the false positive; and
when controlling the vehicle for safety, controlling the vehicle based on the object identified as the false positive.

17. The non-transitory computer readable medium of claim 13, the operations further comprising, when a line of points from the plurality of lines of points is determined not to correlate to any of the plurality of objects:
controlling the vehicle based on the line.

18. The non-transitory computer readable medium of claim 17, the operations further comprising, when the line of points from the plurality of lines of points is determined not to correlate to any of the plurality of objects:
determining whether the line is an air particulate;
when the line is determined to be the air particulate, ignoring the line when controlling the vehicle; and
when the line is not determined to be the air particulate, controlling the vehicle based on the line.

19. The non-transitory computer readable medium of claim 13, wherein each of the plurality of lines of points is captured at a vertical common azimuth angle from the lidar sensor.

20. The non-transitory computer readable medium of claim 13, wherein the correlating comprises determining whether the respective objects from the plurality of objects have substantially the same shape as respective lines from the plurality of lines of points.
